(19) United States
(12) Patent Application Publication
(10) Pub. No.: US 2008/0158064 A1
(43) Pub. Date: Jul. 3, 2008

(54) APERTURE COUPLED MULTIBAND INVERTED-F ANTENNA AND DEVICE USING SAME

(75) Inventors: Lorenzo A. Ponce De Leon, Lake Worth, FL (US); Jacob Marvin, Plantation, FL (US); Naveed Mirza, Boynton Beach, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/618,100

(22) Filed: Dec. 29, 2006

(51) Int. Cl. H01Q 9/04

(52) U.S. Cl. 343/700 MS

(57) ABSTRACT

An antenna structure (200) includes a counterpoise ground plane (202) with a pair of opposing inverted-F elements (204, 206). Each of the F elements has a closed end (208, 210) that is impedance-coupled to the ground plane. A conductive cross member (216) coupled the closed ends together, and a feed point (218) is located on the cross member.

### FIELD OF THE INVENTION

The invention relates generally to communication devices, and more particularly to compact antenna structures for use in multi-mode mobile communication devices.

### BACKGROUND OF THE INVENTION

Mobile communication devices are in widespread use throughout the world, and especially in metropolitan regions of the world. These devices have evolved from simple devices that merely support wireless mobile telephony to multi-function, multi-mode devices that can communicate in a variety of frequency bands using a variety of air interface protocols, modulation schemes, and so on. Manufacturers have worked to keep such device relatively inexpensive, as well as physically small with ever decreasing electrical power consumption rates.

The combination of making the device multi-modal and the desire to keep the device physically small has caused designers and manufactures to find ways of combining circuits and circuit elements such that they can be used for multiple modes, rather than having dedicated circuits and systems for each mode of communication. One of the components of mobile communication devices that occupy a substantial space is the antenna structure and supporting circuitry and mechanical features. Typical whip antennas do not perform well across multiple bands, and require a substantial amount of mechanical support. Using multiple antennas for different bands also increases the space occupied by antennas. Therefore there is a need for a compact, multi-band antenna structure that reduces the amount of space and mechanical features needed in the device.

### SUMMARY OF THE INVENTION

The present invention discloses in one embodiment an antenna structure including a ground plane and a main radiator which includes a pair of opposing F elements. Each of the opposing F elements has an open end and a closed end. The closed ends are impedance-coupled to the ground plane. The opposing F elements are coupled together by a cross member coupling the closed ends together. A feed point is located on the cross member. In an embodiment of the invention at least one of the closed ends of the opposing F elements is impedance-coupled to the ground plane through a capacitor component. The capacitor component may be a varactor. The structure may include a ground plane extension which is impedance-coupled to the cross member. The ground plane and opposing F elements may be on different conductor layers of a circuit board, and when so disposed on different layers, the closed ends of the opposing F elements and the ground plane may overlap. The opposing F elements may be formed along an edge of a circuit board. The ground plane, opposing F elements, and cross member may be coplanar. In another embodiment of the invention, the antenna structure may be incorporated into a mobile communication device.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a block schematic diagram of a multi-mode mobile communication device, in accordance with an embodiment of the invention;

FIG. 2 shows an antenna structure including opposing F elements, in accordance with an embodiment of the invention;

FIG. 3 shows an antenna structure including opposing F elements, in accordance with an alternative embodiment of the invention;

FIG. 4 shows a circuit board implementation of an antenna structure, in accordance with an embodiment of the invention; and

FIG. 5 shows a side cut-away view of a circuit board incorporating an antenna structure, in accordance with an embodiment of the invention.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

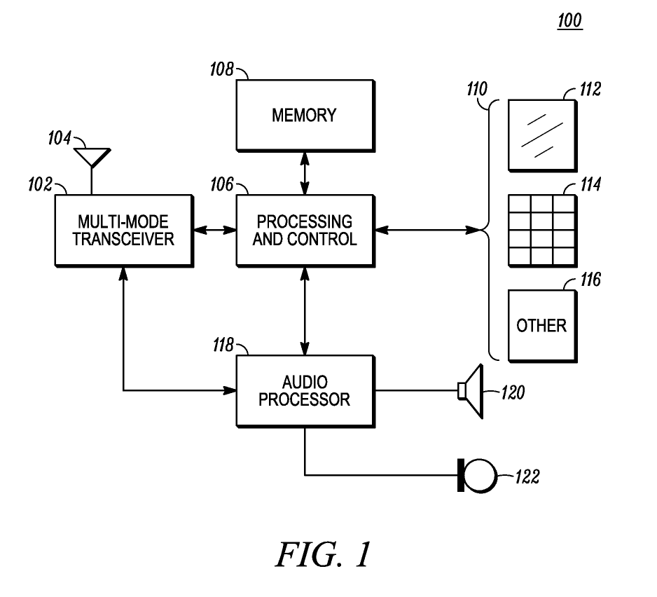

Referring now to FIG. 1, there is shown a block schematic diagram of a multi-mode mobile communication device 100, in accordance with an embodiment of the invention. The device includes a multi-mode transceiver 102 which generates and receives radio frequency signals in accordance with various communication protocols and specifications. The transceiver is coupled to an antenna structure 104, which includes a pair of inverted opposing F elements coupled by a cross member, in accordance with the invention. The transceiver is further coupled to a processing and control block 106. The processing and control block includes processing elements such as microprocessors and digital signal processors, for example. These elements are used to execute instruction code which facilitates control and operation of the device. The processing elements may, for example, process voice and data so that it may be modulated for transmission, or receive demodulated data and process it to produce voice and data information. The processing block is coupled to a memory 108, which is abstracted here to represent a variety of memory elements that may be used for storage of instruction code, data, and other information, as well as memory for instantiating applications and instruction code for execution, and for storing temporary variables used when executing the instruction code. Thus, the memory may include read only memory, programmable memory, volatile and non-volatile memory, random access memory, and so on, as is well known. The processing block may also be used to control a user interface 110. The user interface includes hardware and software elements for interacting with a user to allow the user to operate and control the device, and well as receive information from and put information into the device. The device therefore may include a graphical display 112 or displaying visual information. The device may further include a keypad and other buttons 114 for entering information into the device. Other elements 116 may be used to provide information, such as, for example, a vibratory motor. To facilitate voice communication, and other audio-related task, the device includes an audio processor 118. The audio processor is coupled to the transceiver and processing block, and processes audio signals received at the transceiver so that they may be played over a speaker 120 or other audio transducer. Typically the audio processor receives digital audio signals and coverts them to analog signals. Similarly, the audio processor receives analog audio signals via a microphone 122 and coverts the analog audio signals to digital audio signals, which may be processed and transmitted by the transceiver.

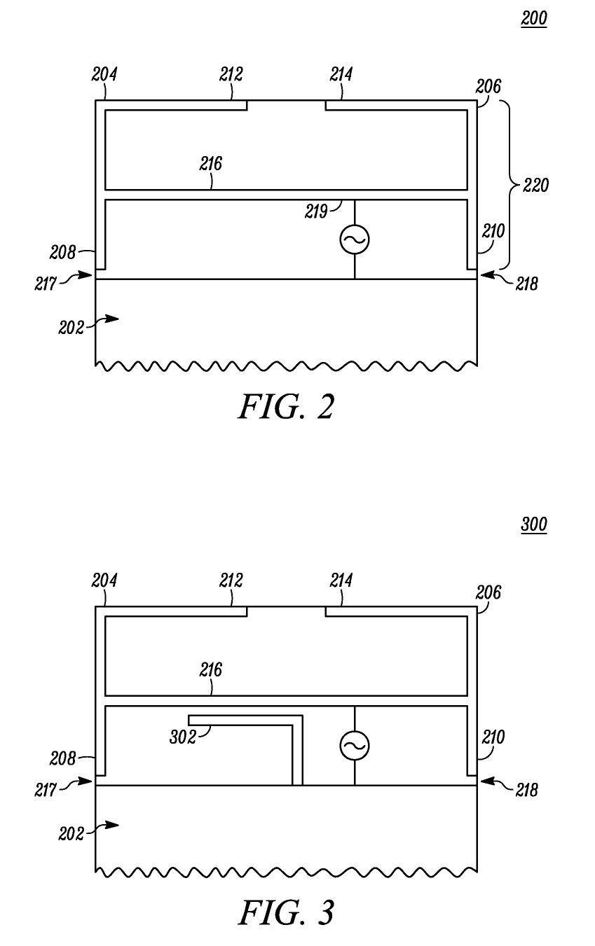

Referring now to FIG. 2, there is shown an antenna structure 200 including opposing F elements, in accordance with an embodiment of the invention. Generally and inverted-F element comprises a closed end coupled to a ground plane. The closed ends extend to a central portion, which terminates at an open end. The open end and central portion typically are perpendicular the closed end. A feed stub connects to the central portion. Thus, the closed end, feed stub, and open end form an F shape, as is well known in the art.

The antenna structure of the present embodiment includes a ground plane 202 which acts as a counterpoise for the antenna structure. The antenna structure has a pair of opposing inverted-F elements 204, 206. Each of the opposing F elements has a closed end 208, 210 which is impedance-coupled to the ground plane. By impedance-coupled it is meant that at the operating frequency of the antenna there appears to be impedance between the closed end and the ground plane that could be modeled as a lumped component, as opposed to the conductor of the closed end simply extending directly to the ground plane conductor. The opposing F elements each further include open ends 212, 214 which extend towards each other. The antenna structure further includes a conductive cross member 216 which couples the closed ends 208, 210 together. The closed ends are impedance-coupled to the ground plane by virtue of gaps or apertures 217, 218 between the closed ends and the ground plane. The coupling may be enhanced or tuned by coupling one or both of the closed ends to the ground plane with a component such as a capacitor or inductive component, or both. Furthermore, the capacitance or inductance value of the component may be adjustable, and may be, for example, a varactor, to allow tuning of the antenna structure. The antenna structure is fed at a feed point 218 on the cross member. The feed point is a point which is selected for impedance matching with the signal source, which may be the multi-mode transceiver such as that shown in FIG. 1. The height 220 of the antenna structure from the ground plane may be selected based on the intended band of operation.

FIG. 3 shows an alternative embodiment of the invention 300. The present embodiment includes the two opposing inverted-F elements 204, 206 with their closed ends impedance-coupled the ground plane, and with a cross member 216 coupling the two closed ends together. In the present embodiment of the invention and extension 302 extends from the ground plane and lies in close proximity to the cross member 216, thus capacitively coupling to the cross member. The degree of coupling may be controlled by the length of the extension disposed parallel to the cross member.

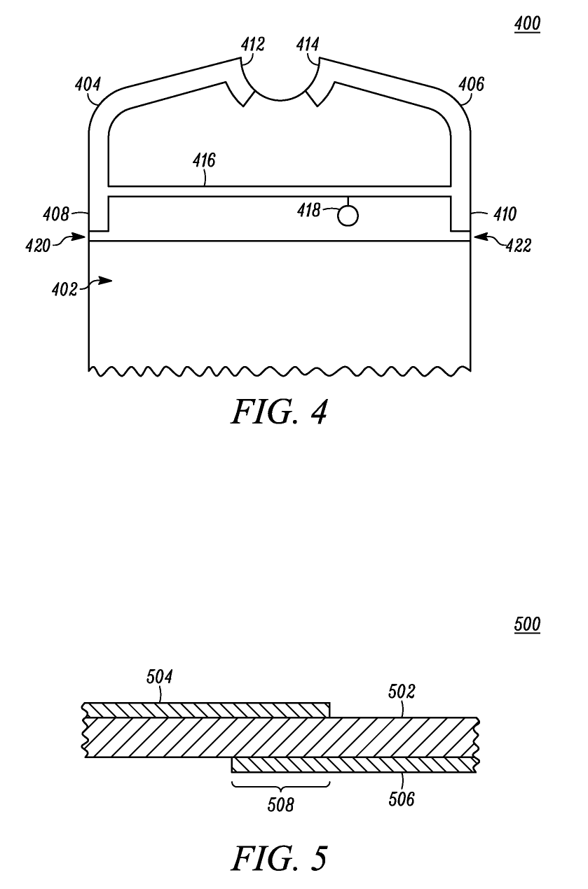

Referring now to FIG. 4, there is shown a circuit board implementation 400 of an antenna structure, in accordance with an embodiment of the invention. The present embodiment of the antenna structure is implemented on a circuit board. The antenna structure is therefore easy to implement by conventional circuit board design techniques and principles. The structure includes a ground plane 402, and pair of opposing inverted-F elements 404, 406 which are coupled to the ground plane at the closed ends 408, 410 of the F elements. The F elements further have open ends 412, 414. The closed ends are coupled together by a cross member 416, in which a feed point 418 is located to feed the antenna structure, or to receive signals therefrom. Each of the closed ends 408, 410 are impedance-coupled to the ground plane and are separated from the ground plane by gaps or apertures 420, 422. However, the open ends 412, 414 extend towards a central or interior region of the circuit board. Furthermore, the F elements substantially follow the edges of the circuit board, including around an arced section of the circuit board.

The antenna structure as shown herein is relatively simple to implement as it may be formed by use of conventional circuit board design techniques. The antenna structure and ground plane may be formed on the same layer of the circuit board, or as shown in FIG. 5, they may be on different layers of the circuit board. FIG. 5 shows a side cut-away view of a circuit board 500 in accordance with an embodiment of the invention. The circuit board includes a substrate 502 that is non-conductive. In a typical circuit board for a mobile communication device, the circuit board will have a plurality of conductor layers and substrate layers alternating, as is well known. In the present example, the closed end 504 of an inverted F antenna structure is disposed on one conductor layer, and the ground plane 506 is disposed on an adjacent conductor layer. To increase the capacitive coupling between the closed end and the ground plane overlap 508 in an overlap region.

This invention can be embodied in other forms without departing from the spirit or essential attributes thereof. Accordingly, reference should be made to the following claims, rather than to the foregoing specification, as indicating the scope of the invention.

What is claimed is:

1. An antenna structure, comprising:
a ground plane; and
a main radiator including a pair of opposing F elements, each of the opposing F elements having an open end, each of the F elements further having a closed end impedance-coupled to the ground plane, a cross member coupling the closed ends together, and a feed point on the cross member.

2. An antenna structure as defined in claim 1, wherein at least one of the closed ends of the opposing F elements is impedance-coupled to the ground plane through a capacitor component.

3. An antenna structure as defined in claim 2, wherein the capacitor component has an adjustable capacitance value.

4. An antenna structure as defined in claim 1, further comprising a ground plane extension which is impedance-coupled to the cross member.

5. An antenna structure as defined in claim 1, wherein the ground plane and opposing F elements are on different conductor layers of a circuit board.

6. An antenna structure as defined in claim 5, wherein the closed ends of the opposing F elements and the ground plane overlap.

7. An antenna structure as defined in claim 1, wherein the opposing F elements are formed along an edge of a circuit board.

8. An antenna structure as defined in claim 1, wherein the ground plane, opposing F elements, and cross member are coplanar.

9. A mobile communication device, comprising:
a multi-mode transceiver; and
an antenna structure comprising:
a ground plane; and
a main radiator including a pair of opposing F elements, each of the opposing F elements having an open end, each of the F elements further having a closed end impedance-coupled to the ground plane, a cross member coupling the closed ends together and a feed point on the cross member.

10. A mobile communication device as defined in claim 9, wherein at least one of the closed ends of the opposing F elements is impedance-coupled to the ground plane through a capacitor component.

11. A mobile communication device as defined in claim 10, wherein the capacitor component is has an adjustable capacitance value.

12. A mobile communication device as defined in claim 9, further comprising a ground plane extension which is impedance-coupled to the cross member.

13. A mobile communication device as defined in claim 9, wherein the ground plane and opposing F elements are on different conductor layers of a circuit board.

14. A mobile communication device as defined in claim 13, wherein the closed ends of the opposing F elements and the ground plane overlap.

15. A mobile communication device as defined in claim 9, wherein the opposing F elements are formed along an edge of a circuit board.

16. A mobile communication device as defined in claim 9, wherein the ground plane, opposing F elements, and cross member are coplanar.
